(19) United States
(12) Patent Application Publication
(10) Pub. No.: US 2026/0243061 A1
(43) Pub. Date: Aug. 20, 2026

(54) SYSTEM, METHOD, AND NON-TRANSITORY COMPUTER-READABLE STORAGE MEDIUM STORING PROGRAM

(71) Applicant: KOMATSU LTD., Tokyo (JP)

(72) Inventors: Shinya HINO, Tokyo (JP); Masaharu MURAI, Tokyo (JP)

(73) Assignee: KOMATSU LTD., Tokyo (JP)

(21) Appl. No.: 19/469,355

(22) PCT Filed: Mar. 28, 2024
(86) PCT No.: PCT/JP2024/012777

§ 371 Date: Sep. 25, 2025

(30) Foreign Application Priority Data
Mar. 28, 2023 (JP) 2023-051148

(51) Int. Cl. E02F 9/26; E02F 9/22; G06T 1/00

(52) U.S. Cl. CPC E02F 9/265; E02F 9/262; G06T 1/0014; E02F 9/2203

(57) ABSTRACT

A control system (200) includes an imaging device (107) that is provided in a work machine (100) and captures imaging data showing a work implement (160), and a processor (210). The processor acquires the imaging data from the imaging device and identifies a shape of a work tool (163), based on the imaging data. The processor controls the work machine, based on the shape, such that the work tool does not come into contact with a virtual wall (VW), which is a surface that prohibits entry of the work implement.

### TECHNICAL FIELD

The present disclosure relates to a system, a method, and a program.

The present application claims priority based on Japanese Patent Application No. 2023-051148, filed Mar. 28, 2023, the content of which is incorporated herein by reference.

### BACKGROUND ART

There is a known technique for setting virtual walls in a space in order to limit the operating range of a work machine. A control device for the work machine can control the work machine such that it does not exceed the virtual wall by limiting the amount of movement of an actuator of the work machine in accordance with the distance between the virtual wall and the work machine.

Furthermore, Patent Document 1 discloses a technique for preventing a work tool from entering an interference prevention area by defining a virtual circle having a center on the rotation axis of the work tool and a radius to the tip end of the work tool, and determining the relationship between the virtual circle and the interference prevention area.

### CITATION LIST

### Patent Literature

Patent Document 1: JP H9-256403 A

### SUMMARY OF INVENTION

### Technical Problem

Some work machines are capable of attaching various work tools to the tip end of the work implement. Since there are various shapes of work tools, when the work tool is replaced, the parameters related to the control need to be changed. Setting parameters every time the work tool is replaced is time-consuming.

An object of the present disclosure is to provide a system, a method, and a program that can easily determine parameters related to the control of a replaceable work tool.

### Solution to Problem

A system according to a first aspect of the present disclosure controls a work machine including a work implement to which a work tool is attachable at a tip end. The system includes an imaging device that is provided in the work machine and captures imaging data showing the work implement; and a processor. The processor acquires the imaging data from the imaging device, and identifies a shape of the work tool based on the imaging data. The processor controls the work machine, based on the shape, such that the work tool does not come into contact with a virtual wall, which is a surface that prohibits entry of the work implement.

A method according to a second aspect of the present disclosure is a method for controlling a work machine including a work implement to which a work tool is attachable at a tip end, the method including an acquisition step, an identification step, and a control step. In the acquisition step, from an imaging device that is provided in the work machine and captures imaging data showing the work implement, the imaging data is acquired. In the identification step, a shape of the work tool is identified based on the imaging data. In the control step, the work machine is controlled based on the shape such that the work tool does not come into contact with a virtual wall, which is a surface that prohibits entry of the work implement.

A program according to a third aspect of the present invention controls a work machine including a work implement to which a work tool is attachable at a tip end. The program causes a computer to execute an acquisition step, an identification step, and a control step. In the acquisition step, from an imaging device that is provided in the work machine and captures imaging data showing the work implement, the imaging data is acquired. In the identification step, a shape of the work tool is identified based on the imaging data. In the control step, the work machine is controlled based on the shape such that the work tool does not come into contact with a virtual wall, which is a surface that prohibits entry of the work implement.

### Advantageous Effects of Invention

According to the above aspects, parameters related to the control of the replaceable work tool can be easily determined.

### BRIEF DESCRIPTION OF DRAWINGS

FIG. 1 is a schematic diagram illustrating a configuration of a work machine according to a first embodiment.

FIG. 2 is a diagram illustrating a drive system of the work machine according to the first embodiment.

FIG. 3 is a schematic block diagram illustrating a configuration of a control device according to the first embodiment.

FIG. 4 is a diagram illustrating a relationship between a virtual sphere and a virtual wall in the first embodiment.

FIG. 5 is a diagram illustrating a relationship between a virtual sphere and an outer shell of a bucket in the first embodiment.

FIG. 6 is a diagram illustrating an example of resetting of the virtual wall in association with the revolution of a revolving body in the first embodiment.

FIG. 7 is a flowchart (part 1) showing a shape identification process of an attachment in the first embodiment.

FIG. 8 is a flowchart (part 2) showing the shape identification process of the attachment in the first embodiment.

FIG. 9 is a diagram illustrating an example of a screen in the shape identification process according to the first embodiment.

FIG. 10 is a flowchart (part 1) showing update and intervention control of the virtual wall set in the first embodiment.

FIG. 11 is a flowchart (part 2) showing update and intervention control of the virtual wall set in the first embodiment.

FIG. 12 is a flowchart showing a shape identification process of an attachment in a second embodiment.

FIG. 13 is a diagram illustrating an example of a screen in the shape identification process according to the second embodiment.

FIG. 14 is a diagram illustrating a configuration of a work system according to another embodiment.

### DESCRIPTION OF EMBODIMENTS

### First Embodiment

### Configuration of Work Machine

Hereinafter, embodiments will be described in detail with reference to the drawings.

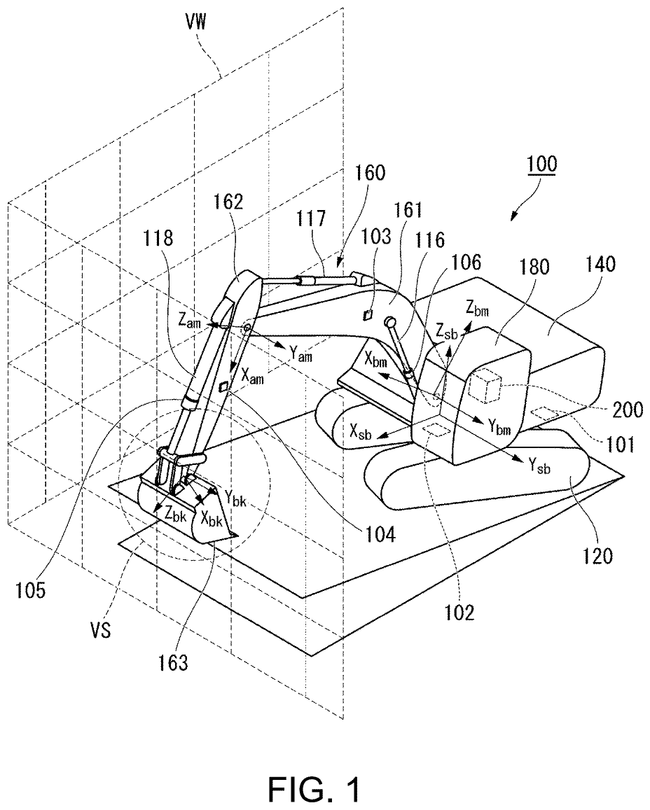

FIG. 1 is a schematic diagram illustrating a configuration of a work machine 100 according to a first embodiment. The work machine 100 according to the first embodiment is, for example, a hydraulic excavator. The work machine 100 includes a traveling body 120, a revolving body 140, a work implement 160, a cab 180, and a control device 200. The work machine 100 according to the first embodiment generates a virtual wall VW through operation by an operator, and is controlled such that the work machine 100 does not come into contact with the virtual wall VW. This enables the operator to operate the work machine 100 so as not to enter the restricted area.

The traveling body 120 supports the work machine 100 such that the work machine 100 can travel. The traveling body 120 is, for example, a pair of left and right endless tracks.

The revolving body 140 is supported by the traveling body 120 to be capable of revolving about a revolution center.

The work implement 160 is operably supported on the revolving body 140. The work implement 160 is hydraulically driven. The work implement 160 includes a boom 161, an arm 162, and an attachment 163 which is a working tool. The attachment 163 is an example of a work tool. The attachment 163 in the example illustrated in FIG. 1 is a bucket. A base end portion of the boom 161 is rotatably attached to the revolving body 140. A base end portion of the arm 162 is rotatably attached to a tip end portion of the boom 161. The attachment 163 is rotatably attached to a tip end portion of the arm 162. Here, a portion of the revolving body 140 to which the work implement 160 is attached is referred to as a front portion. In addition, with respect to the revolving body 140, with the front portion being taken as the reference portion, a portion on a side opposite thereto is referred to as a rear portion, a portion on the left side is referred to as a left portion, and a portion on the right side is referred to as a right portion.

The cab 180 is provided at the front portion of the revolving body 140. In the cab 180, an operation device 141 for the operator to operate the work machine 100, and a monitor device 142 which is a man-machine interface for the control device 200 are provided. The monitor device 142 is realized by, for example, a computer equipped with a touch panel.

The control device 200 controls the traveling body 120, the revolving body 140, and the work implement 160 based on the operation of the operation device by the operator. The control device 200 is provided, for example, inside the cab 180.

### Drive System of Work Machine 100

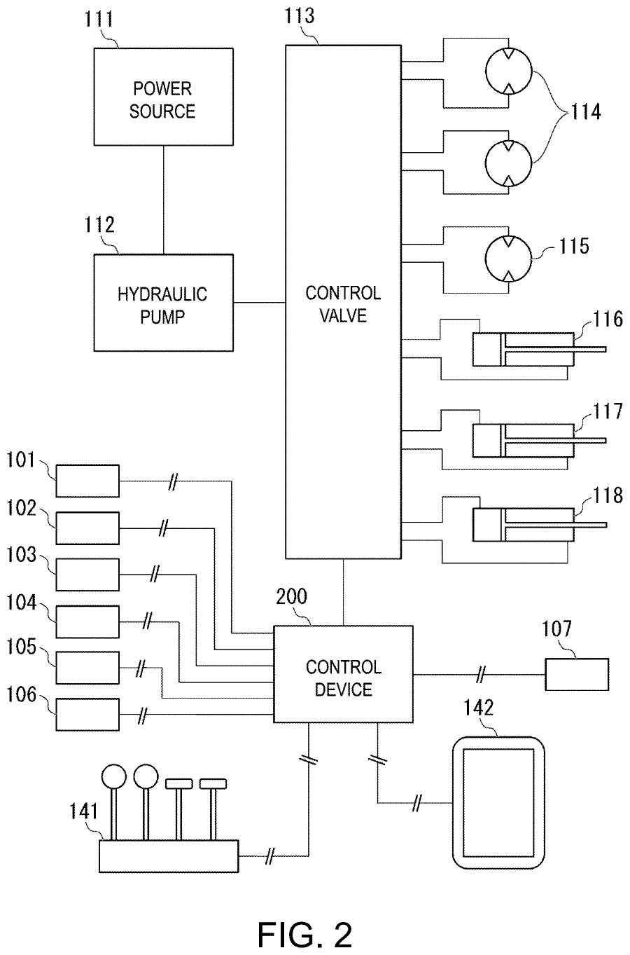

FIG. 2 is a diagram illustrating a drive system of the work machine 100 according to the first embodiment.

The work machine 100 includes a plurality of actuators for driving the work machine 100. Specifically, the work machine 100 includes a power source 111, a hydraulic pump 112, a control valve 113, a pair of travel motors 114, a revolution motor 115, a boom cylinder 116, an arm cylinder 117, and an attachment cylinder 118.

The power source 111 is a prime mover that drives the hydraulic pump 112. The power source 111 is, for example, an engine.

The hydraulic pump 112 is driven by the power source 111 and supplies hydraulic oil to the travel motor 114, the revolution motor 115, the boom cylinder 116, the arm cylinder 117, and the attachment cylinder 118 via the control valve 113.

The control valve 113 controls the flow rate of hydraulic oil supplied from the hydraulic pump 112 to the travel motor 114, the revolution motor 115, the boom cylinder 116, the arm cylinder 117, and the attachment cylinder 118.

The travel motor 114 is driven by hydraulic oil supplied from the hydraulic pump 112 to drive the traveling body 120.

The revolution motor 115 is driven by hydraulic oil supplied from the hydraulic pump 112 to revolve the revolving body 140 relative to the traveling body 120.

The boom cylinder 116 is a hydraulic cylinder for driving the boom 161. A base end portion of the boom cylinder 116 is attached to the revolving body 140. A tip end portion of the boom cylinder 116 is attached to the boom 161.

The arm cylinder 117 is a hydraulic cylinder for driving the arm 162. A base end portion of the arm cylinder 117 is attached to the boom 161. A tip end portion of the arm cylinder 117 is attached to the arm 162.

The attachment cylinder 118 is a hydraulic cylinder for driving the attachment 163. A base end portion of the attachment cylinder 118 is attached to the arm 162. A tip end portion of the attachment cylinder 118 is attached to the attachment 163.

### Measurement System of Work Machine 100

The work machine 100 includes a plurality of sensors for measuring the posture and position of the work machine 100. Specifically, the work machine 100 includes an inclination measuring instrument 101, a revolution angle sensor 102, a boom angle sensor 103, an arm angle sensor 104, an attachment angle sensor 105, a payload meter 106, and an imaging device 107.

The inclination measuring instrument 101 measures the posture of the revolving body 140. The inclination measuring instrument 101 measures the inclination (for example, a roll angle, a pitch angle, and a yaw angle) of the revolving body 140 with respect to a horizontal plane. An example of the inclination measuring instrument 101 is an inertial measurement unit (IMU). In this case, the inclination measuring instrument 101 measures the acceleration and angular velocity of the revolving body 140, and calculates an inclination of the revolving body 140 with respect to the horizontal plane based on the measurement results. The inclination measuring instrument 101 is installed, for example, below the cab 180. The inclination measuring instrument 101 outputs the posture data of the revolving body 140, which is a measurement value, to the control device 200.

The revolution angle sensor 102 measures a revolution angle of the revolving body 140 relative to the traveling body 120. The measurement value of the revolution angle sensor 102 indicates zero, for example, when the directions of the traveling body 120 and the revolving body 140 coincide with each other. The revolution angle sensor 102 is installed, for example, at the revolution center of the revolving body 140. The revolution angle sensor 102 outputs revolution angle data, which is a measurement value, to the control device 200.

The boom angle sensor 103 measures a boom angle, which is a rotation angle of the boom 161 relative to the revolving body 140. The boom angle sensor 103 may be an IMU attached to the boom 161. In this case, the boom angle sensor 103 measures the boom angle based on the inclination of the boom 161 with respect to the horizontal plane and the inclination of the revolving body measured by the inclination measuring instrument 101. The measurement value of the boom angle sensor 103 indicates zero when, for example, the direction of a straight line passing through the base end and the tip end of the boom 161 coincides with the front-rear direction of the revolving body 140. Note that the boom angle sensor 103 according to another embodiment may be a stroke sensor attached to the boom cylinder 116. Furthermore, the boom angle sensor 103 according to another embodiment may be a rotation sensor provided on a pin connecting the revolving body 140 and the boom 161. The boom angle sensor 103 outputs boom angle data, which is a measurement value, to the control device 200.

The arm angle sensor 104 measures an arm angle, which is a rotation angle of the arm 162 relative to the boom 161. The arm angle sensor 104 may be an IMU attached to the arm 162. In this case, the arm angle sensor 104 measures the arm angle based on the inclination of the arm 162 with respect to the horizontal plane and the boom angle measured by the boom angle sensor 103. The measurement value of the arm angle sensor 104 indicates zero, for example, when the direction of a straight line passing through the base end and the tip end of the arm 162 coincides with the direction of a straight line passing through the base end and the tip end of the boom 161. In addition, the arm angle sensor 104 according to another embodiment may be configured such that a stroke sensor is attached to the arm cylinder 117 to calculate the angle. Furthermore, the arm angle sensor 104 according to another embodiment may be a rotation sensor provided on a pin connecting the boom 161 and the arm 162. The arm angle sensor 104 outputs arm angle data, which is a measurement value, to the control device 200.

The attachment angle sensor 105 measures an attachment angle, which is a rotation angle of the attachment 163 relative to the arm 162. The attachment angle sensor 105 may be a stroke sensor provided on the attachment cylinder 118 for driving the attachment 163. In this case, the attachment angle sensor 105 measures the attachment angle based on the stroke amount of the attachment cylinder 118. The measurement value of the attachment angle sensor 105 indicates zero, for example, when the direction of a straight line passing through the base end and the tip end portion of the attachment 163 coincides with the direction of a straight line passing through the base end and the tip end of the arm 162. Note that the attachment angle sensor 105 according to another embodiment may be a rotation sensor provided on a pin connecting the arm 162 and the attachment 163. In addition, the attachment angle sensor 105 according to another embodiment may be an IMU attached to the attachment 163. The attachment angle sensor 105 outputs attachment angle data, which is a measurement value, to the control device 200.

The payload meter 106 measures a weight of the load held by the attachment 163. The payload meter 106 measures, for example, a bottom pressure of the cylinder of the boom 161 and converts the bottom pressure into the weight of the load. Also for example, the payload meter 106 may be a load cell. The payload meter 106 outputs load weight data, which is a measurement value, to the control device 200.

The imaging device 107 is provided on the revolving body 140 such that the work implement 160 is shown within the imaging range. For example, the imaging device 107 may be provided on the ceiling of the cab 180. The imaging device 107 outputs imaging data to the control device 200. Examples of the imaging device 107 include a camera, a stereo camera, a LiDAR, a laser scanner, and the like. The imaging data may be two-dimensional image data or three-dimensional point cloud data.

### Configuration of Control Device 200

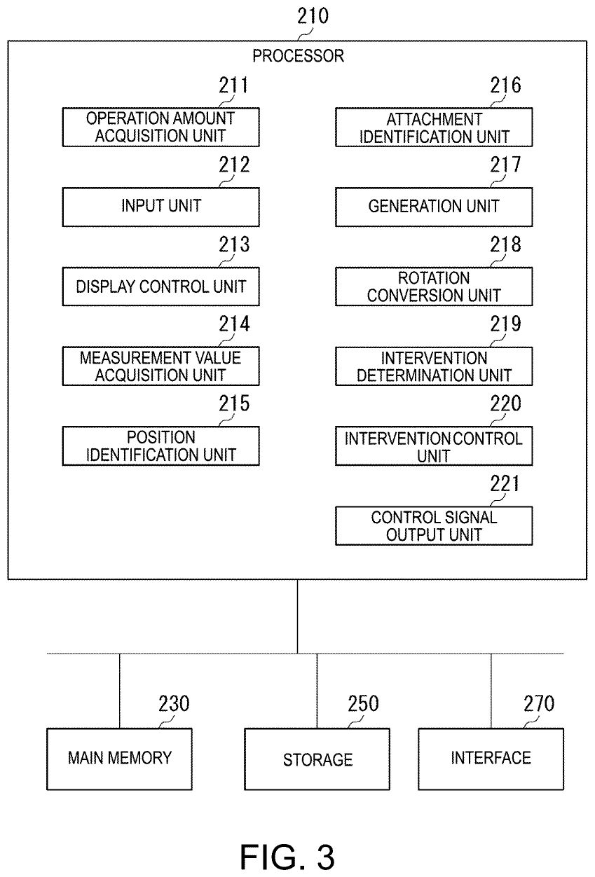

FIG. 3 is a schematic block diagram illustrating a configuration of the control device 200 according to the first embodiment.

The control device 200 is a computer including a processor 210, a main memory 230, a storage 250, and an interface 270. The control device 200 is an example of a control system. The control device 200 receives measurement values from the inclination measuring instrument 101, the revolution angle sensor 102, the boom angle sensor 103, the arm angle sensor 104, the attachment angle sensor 105, and the payload meter 106.

The storage 250 is a non-transitory, tangible storage medium. Examples of the storage 250 include a magnetic disk, an optical disc, a magneto-optical disk, and a semiconductor memory. The storage 250 may be an internal medium directly connected to the bus of the control device 200, or may be an external medium connected to the control device 200 via the interface 270 or a communication line. The storage 250 stores a control program for controlling the work machine 100.

The control program may be a program for realizing a part of the functions to be exhibited by the control device 200. For example, the control program may be a program that exhibits a function in combination with other programs already stored in the storage 250 or in combination with other programs implemented in other devices. In addition, in other embodiments, the control device 200 may include, in addition to or instead of the above configuration, a custom large scale integrated circuit (LSI) such as a programmable logic device (PLD). Examples of the PLD include a programmable array logic (PAL), a generic array logic (GAL), a complex programmable logic device (CPLD), and a field programmable gate array (FPGA). In this case, some or all of the functions realized by the processor may be realized by the integrated circuit.

The storage 250 records geometry data representing the dimensions of the revolving body 140, the boom 161, and the arm 162. Geometry data is data that represents the position of an object in a predetermined coordinate system.

### Software Configuration

By executing the control program, the processor 210 includes an operation amount acquisition unit 211, an input unit 212, a display control unit 213, a measurement value acquisition unit 214, a position identification unit 215, an attachment identification unit 216, a generation unit 217, a rotation conversion unit 218, an intervention determination unit 219, an intervention control unit 220, and a control signal output unit 221.

The operation amount acquisition unit 211 acquires an operation signal indicating an operation amount of each actuator from the operation device 141.

The input unit 212 receives an operation input by an operator via the monitor device 142. In particular, when the attachment 163 is replaced, the input unit 212 receives an input from the operator to execute a shape identification process of the attachment 163, and starts the shape identification process of the attachment 163, which will be described later.

The display control unit 213 outputs screen data to be displayed on the monitor device 142 to the monitor device 142.

The measurement value acquisition unit 214 acquires measurement values from the inclination measuring instrument 101, the revolution angle sensor 102, the boom angle sensor 103, the arm angle sensor 104, the attachment angle sensor 105, and the payload meter 106. The measurement value acquisition unit 214 acquires imaging data from the imaging device 107.

The position identification unit 215 identifies a position of an outer shell of the work machine 100 in a vehicle body coordinate system. The outer shell of the work machine 100 refers to an outer shape of the work machine 100. The outer shell of the work machine 100 is defined by shapes that form the outer shapes of the revolving body 140 and the work implement 160, for example. Specifically, the position identification unit 215 identifies a plurality of points on the outer shell of the work machine 100 in the vehicle body coordinate system and a position of a control point P of the attachment 163 based on the various measurement values acquired by the measurement value acquisition unit 214, the geometry data recorded in the storage 250, and the data identified by the attachment identification unit 216. The plurality of points on the outer shell identified by the position identification unit 215 include an end of the arm 162 on the attachment 163 side (arm top), an end of the arm 162 on the boom 161 side (arm bottom), and a point behind a counterweight of the revolving body 140. The vehicle body coordinate system is an orthogonal coordinate system whose origin is a representative point of the revolving body 140 (for example, a point passing through the revolution center). The calculations of the position identification unit 215 will be described later. Note that the points identified by the position identification unit 215 are not limited thereto.

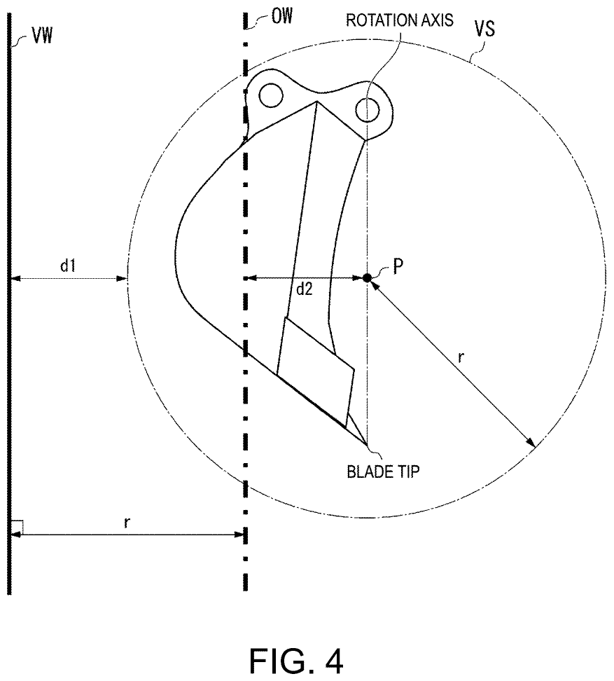

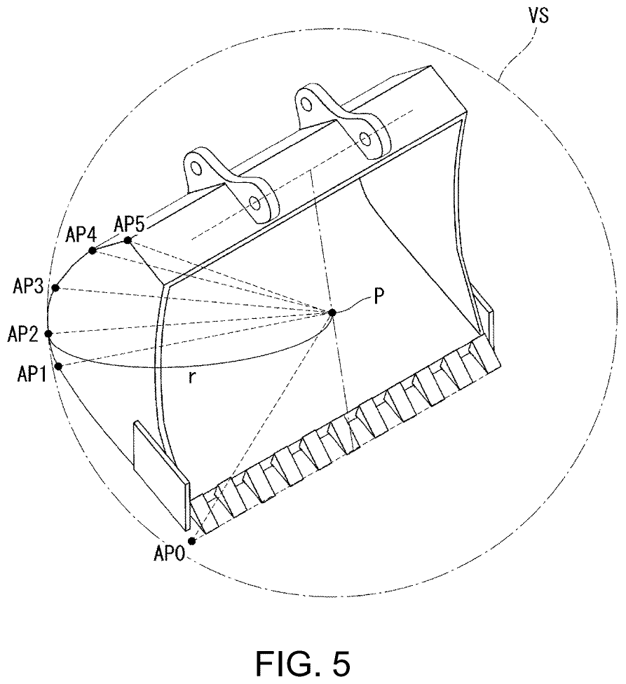

The control point P of the attachment 163 is the center of a virtual sphere VS when the attachment 163 is regarded as a sphere (virtual sphere VS). In order to simply represent the attachment 163, the virtual sphere VS is defined so as to include the attachment 163 with the control point P as its center. FIG. 4 is a diagram illustrating a relationship between the virtual sphere VS and the virtual wall VW in the first embodiment. FIG. 5 is a diagram illustrating a relationship between the virtual sphere VS and the outer shell of the bucket in the first embodiment. In the first embodiment, the attachment 163 is a bucket, and as illustrated in FIGS. 4 and 5, the control point P is a midpoint of a line segment connecting a midpoint of a pin (rotation axis) connecting the arm 162 and the bucket and a midpoint of a blade tip (tip end portion) of the bucket. A radius r of the virtual sphere VS in the first embodiment is equal to a distance from the control point P to the farthest point on the outer shell of the bucket. Therefore, the virtual sphere VS includes the bucket. In the example of FIG. 5, points AP0, AP1, AP2, AP3, AP4, and AP5 are identified as points for simply expressing the outer shell of the bucket, and among these, the point farthest from the control point P is AP2. Therefore, in the example of FIG. 5, the radius r is equal to a distance from the control point P to the point AP2.

By setting the control point P of the bucket at the midpoint of the line segment connecting the midpoint of the rotation axis of the bucket and the midpoint of the tip end portion of the bucket, the gap between the bottom surface of the bucket and the virtual sphere VS can be reduced. On the other hand, the opening surface of the bucket is at a greater distance from the virtual sphere VS than the bottom surface, but in a backhoe excavator, the opening surface of the bucket does not normally face the front of the work machine 100, and thus there are few situations in which this affects operability. In addition, since the shape of the bucket is close to a hemisphere, setting the control point P to the midpoint of the line segment connecting the midpoint of the rotation axis of the bucket and the midpoint of the tip end portion of the bucket has an advantage of making it easier for the operator to imagine the virtual sphere VS when operating the bucket.

The attachment identification unit 216 identifies the shape of the attachment 163 based on the imaging data acquired by the measurement value acquisition unit 214 and the position of the arm top identified by the position identification unit 215, and determines the position of the control point P of the attachment 163 and the radius of the virtual sphere VS.

The position of the control point P is expressed as a position (x_{cp}, y_{cp}, z_{cp}) in an attachment coordinate system, which is a local coordinate system. The attachment coordinate system is a coordinate system that is configured with an Xₐₜ axis extending in the direction of the tip end portion, a Yₐₜ axis extending in the direction in which the pin extends, and a Zₐₜ axis orthogonal to the Xₐₜ axis and the Yₐₜ axis, with reference to the position of the pin connecting the attachment 163 and the arm 162. Note that the attachment coordinate system is a predetermined coordinate system, and does not depend on the shape of the attachment 163 identified by the attachment identification unit 216. Therefore, the Xₐₜ axis does not necessarily actually pass through the tip end of the attachment 163. The control point P is a point that is uniquely identified in a coordinate system based on the attachment 163.

When the input unit 212 receives an instruction to generate the virtual wall VW from an operator, the generation unit 217 calculates parameters of the virtual wall VW based on the position of the tip end portion of the attachment 163 identified by the position identification unit 215. The generation unit 217 records the parameters of the generated virtual wall VW in the vehicle body coordinate system in the main memory 230.

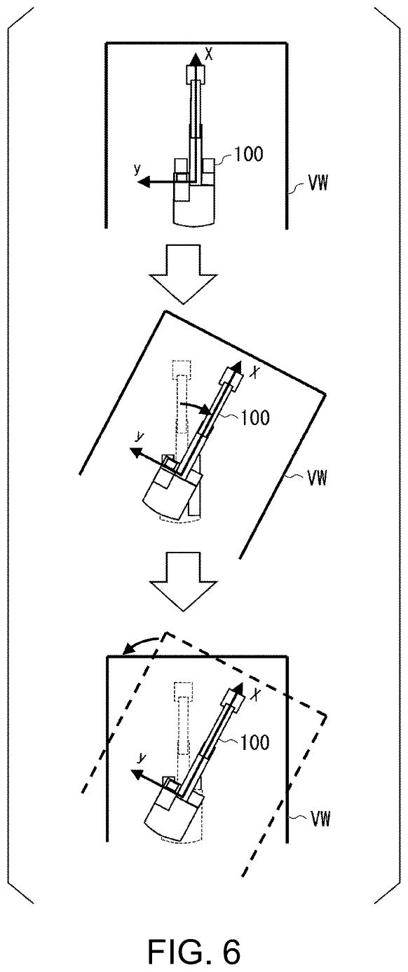

The rotation conversion unit 218 updates the parameters of the virtual wall VW stored in the main memory 230 as the revolving body 140 revolves. Specifically, the rotation conversion unit 218 performs rotation conversion on the parameters of the virtual wall VW around the origin of the vehicle body coordinate system by the amount of change in the pitch angle, the roll angle, and the yaw angle measured by the inclination measuring instrument 101. FIG. 6 is a diagram illustrating an example of resetting the virtual wall VW in association with the revolution of the revolving body in the first embodiment. For example, as illustrated in FIG. 6, when the revolving body 140 revolves after the virtual wall VW is set, the rotation conversion unit 218 calculates the amount of change in the roll angle, the pitch angle, and the yaw angle caused by the revolution of the revolving body 140 by referring to the measurement values of the inclination measuring instrument 101 acquired by the measurement value acquisition unit 214, and performs rotation conversion on the parameters of the virtual wall VW around the origin of the vehicle body coordinate system. This enables the rotation conversion unit 218 to cancel the rotation of the virtual wall VW caused by the revolution of the revolving body 140.

The intervention determination unit 219 determines whether or not to limit the revolution speed of the revolving body 140 or the speed of the work implement 160 based on a positional relationship between the plurality of points of the outer shell identified by the position identification unit 215 and the virtual wall VW, and a positional relationship between the virtual sphere VS of the attachment 163 and the virtual wall VW. Hereinafter, limiting the speed of the revolving body 140 or the work implement 160 by the control device 200 is also referred to as intervention control. Specifically, the intervention determination unit 219 obtains the minimum revolution angle at which the virtual wall VW comes into contact with at least one of the plurality of points on the outer shell, and when the minimum revolution angle is equal to or less than a predetermined angle, the intervention determination unit 219 determines that intervention control is to be performed on the revolving body 140. In addition, the intervention determination unit 219 obtains a minimum distance between the virtual wall VW and the work implement 160, and when the minimum distance is equal to or less than a predetermined distance, the intervention determination unit 219 determines that intervention control should be performed on the work implement 160. At this time, the intervention determination unit 219 obtains the distance to the attachment 163 based on the virtual sphere VS. In order to reduce the amount of calculation, the intervention determination unit 219 identifies an offset wall OW obtained by offsetting the virtual wall VW by the radius r of the virtual sphere VS as illustrated in FIG. 4. A distance d1 between the virtual sphere VS and the virtual wall VW is equal to a distance d2 between the control point P and the offset wall OW. Therefore, the intervention determination unit 219 calculates the distance d2 between the control point P and the offset wall OW to obtain the distance d1 between the virtual sphere VS and the virtual wall VW.

When the intervention determination unit 219 determines that intervention control is to be performed, the intervention control unit 220 controls the operation amount of the intervention target among the operation amounts acquired by the operation amount acquisition unit 211.

The control signal output unit 221 outputs the operation amount acquired by the operation amount acquisition unit 211 or the operation amount controlled by the intervention determination unit 219 to the control valve 113.

### Calculation of Position Identification Unit 215

Here, a method for identifying the positions of points on the outer shell of the work machine 100 by the position identification unit 215 will be described. The position identification unit 215 identifies the positions of the points on the outer shell based on the various measurement values acquired by the measurement value acquisition unit 214 and the geometry data recorded in the storage 250. The storage 250 records geometry data representing the dimensions of the revolving body 140, the boom 161, and the arm 162. Furthermore, the position identification unit 215 identifies the position of the virtual sphere VS using the identified position of the arm top and the position and the radius of the control point P of the virtual sphere VS of the attachment 163 identified by the attachment identification unit 216.

The geometry data of the revolving body 140 indicates the positions (x_{bm}, y_{bm}, z_{bm}) of the pins supporting the boom 161 of the revolving body 140 in the vehicle body coordinate system, which is a local coordinate system, and the positions (xₛₚ, yₛₚ, zₛₚ) of points on the outer shell of the revolving body 140. Examples of points on the outer shell of the revolving body 140 include points that are likely to come into contact with a wall surface when revolving, such as protruding points of a counterweight. The vehicle body coordinate system is a coordinate system that is configured with an X_{sb} axis extending in the front-rear direction, a Y_{sb} axis extending in the left-right direction, and a Z_{sb} axis extending in the up-down direction, with reference to the revolution center of the revolving body 140. The up-down direction of the revolving body 140 does not necessarily coincide with the vertical direction.

The geometry data of the boom 161 indicates the position (xₐₘ, yₐₘ, zₐₘ) of the boom top in a boom coordinate system, which is a local coordinate system. The boom coordinate system is a coordinate system that is configured with an X_{bm} axis extending in the longitudinal direction, a Y_{bm} axis extending in the direction in which the pin extends, and a Z_{b}m axis orthogonal to the X_{bm} axis and the Y_{bm} axis, with reference to the position of the pin connecting the boom 161 and the revolving body 140. The position of the boom top is the position of the pin that connects the boom 161 and the arm 162. The boom top is a point on the outer shell of the work machine 100.

The geometry data of the arm 162 indicates the position (xₐₜ, yₐₜ, zₐₜ) of the arm top in an arm coordinate system, which is a local coordinate system. The arm coordinate system is a coordinate system that is configured with an Xₐₘ axis extending in the longitudinal direction, a Yₐₘ axis extending in the direction in which the pin extends, and a Zₐₘ axis orthogonal to the Xₐₘ axis and the Yₐₘ axis, with reference to the position of the pin connecting the arm 162 and the boom 161. The position of the arm top is the position of the pin that connects the arm 162 and the attachment 163. The arm top is a point on the outer shell of the work machine 100.

The position identification unit 215 generates a boom-vehicle body transformation matrix T^{bm}_{sb} for transforming from the boom coordinate system to the vehicle body coordinate system based on a measurement value of a boom angle θ_{bm} acquired by the measurement value acquisition unit 214 and the geometry data of the revolving body 140, using the following equation (1). The boom-vehicle body transformation matrix T^{bm}_{sb} is a matrix that rotates by the boom angle θ_{bm} around the Y_{bm} axis and translates by the deviation (x_{bm}, y_{bm}, z_{bm}) between the origin of the vehicle body coordinate system and the origin of the boom coordinate system.

In addition, the position identification unit 215 obtains the product of the position of the boom top in the boom coordinate system indicated by the geometry data of the boom 161 and the boom-vehicle body transformation matrix T^{bm}_{sb}, thereby obtaining the position of the boom top in the vehicle body coordinate system.

$$\begin{matrix}[ Math . 1 ] & \\ {T}_{sb}^{bm} = [ \begin{matrix}co s {θ}_{b m} & 0 & sin {θ}_{b m} & {x}_{bm} \\ 0 & 1 & 0 & {y}_{bm} \\ - s in {θ}_{b m} & 0 & cos {θ}_{b m} & {z}_{bm} \\ 0 & 0 & 0 & 1\end{matrix} ] & ( 1 )\end{matrix}$$

The position identification unit 215 generates an arm-boom transformation matrix T^{am}_{bm} for transforming from the arm coordinate system to the boom coordinate system based on a measurement value of an arm angle θₐₘ acquired by the measurement value acquisition unit 214 and the geometry data of the boom 161, using the following equation (2). The arm-boom transformation matrix T^{am}_{bm} is a matrix that rotates by the arm angle θₐₘ around the Yₐₘ axis and translates by the deviation (xₐₘ, yₐₘ, zₐₘ) between the origin of the boom coordinate system and the origin of the arm coordinate system. In addition, the position identification unit 215 generates an arm-vehicle body transformation matrix T^{m}sb for transforming from the arm coordinate system to the vehicle body coordinate system by obtaining the product of the boom-vehicle body transformation matrix T^{bm}_{sb} and the arm-boom transformation matrix T^{am}_{bm}. In addition, the position identification unit 215 obtains the product of the position of the arm top in the arm coordinate system indicated by the geometry data of the arm 162 and the arm-vehicle body transformation matrix T^{am}_{sb}, thereby obtaining the position of the arm top in the vehicle body coordinate system.

$$\begin{matrix}[ Math . 2 ] & \\ {T}_{bm}^{am} = [ \begin{matrix}cos {θ}_{am} & 0 & sin {θ}_{am} & {x}_{am} \\ 0 & 1 & 0 & {y}_{am} \\ - s in {θ}_{am} & 0 & cos {θ}_{am} & {z}_{am} \\ 0 & 0 & 0 & 1\end{matrix} ] & ( 2 )\end{matrix}$$

The position identification unit 215 generates an attachment-arm transformation matrix T^{at}ₐₘ for transforming from the attachment coordinate system to the arm coordinate system based on a measurement value of an attachment angle θₐₜ acquired by the measurement value acquisition unit 214 and the geometry data of the arm 162, using the following equation (3). The attachment-arm transformation matrix T^{at}ₐₘ is a matrix that rotates by the attachment angle θₐₜ around the Yₐₜ axis and translates by the deviation (xₐₜ, yₐₜ, zₐₜ) between the origin of the arm coordinate system and the origin of the attachment coordinate system. In addition, the position identification unit 215 generates an attachment-vehicle body transformation matrix T^{at}_{sb} for transforming from the attachment coordinate system to the vehicle body coordinate system by obtaining the product of the arm-vehicle body transformation matrix T^{am}_{sb} and the attachment-arm transformation matrix T^{at}ₐₘ.

$$\begin{matrix}[ Math . 3 ] & \\ {T}_{am}^{at} = [ \begin{matrix}cos {θ}_{at} & 0 & sin {θ}_{a t} & {x}_{at} \\ 0 & 1 & 0 & {y}_{at} \\ - s in {θ}_{at} & 0 & cos {θ}_{a t} & {z}_{at} \\ 0 & 0 & 0 & 1\end{matrix} ] & ( 3 )\end{matrix}$$

The position identification unit 215 obtains the product of the position of the control point P of the attachment 163 identified by the attachment identification unit 216 and the attachment-vehicle body transformation matrix T^{at}_{sb}, thereby obtaining the position of the control point P of the attachment 163 in the vehicle body coordinate system.

### Control Method for Work Machine 100

Hereinafter, a control method for the work machine 100 according to the first embodiment will be described.

First, the operator of the work machine 100 attaches the attachment 163 to the work implement 160, and then operates the monitor device 142 to perform a shape identification process of the attachment 163.

### Shape Identification Process of Attachment 163

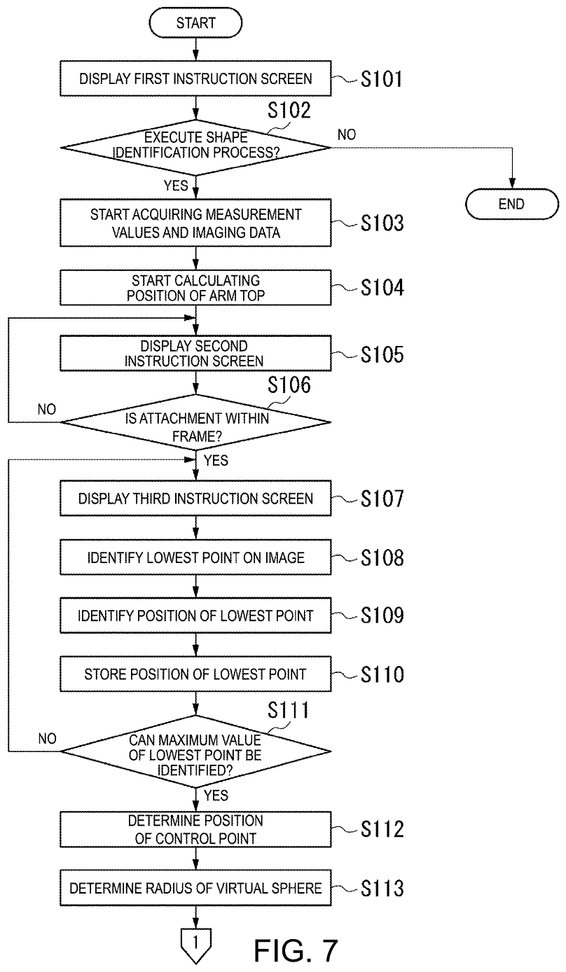

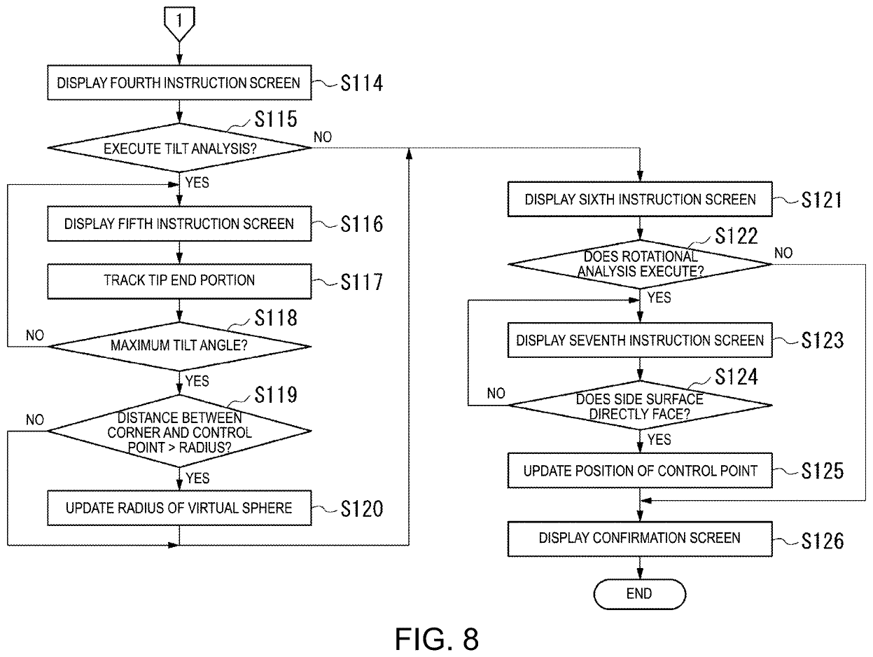

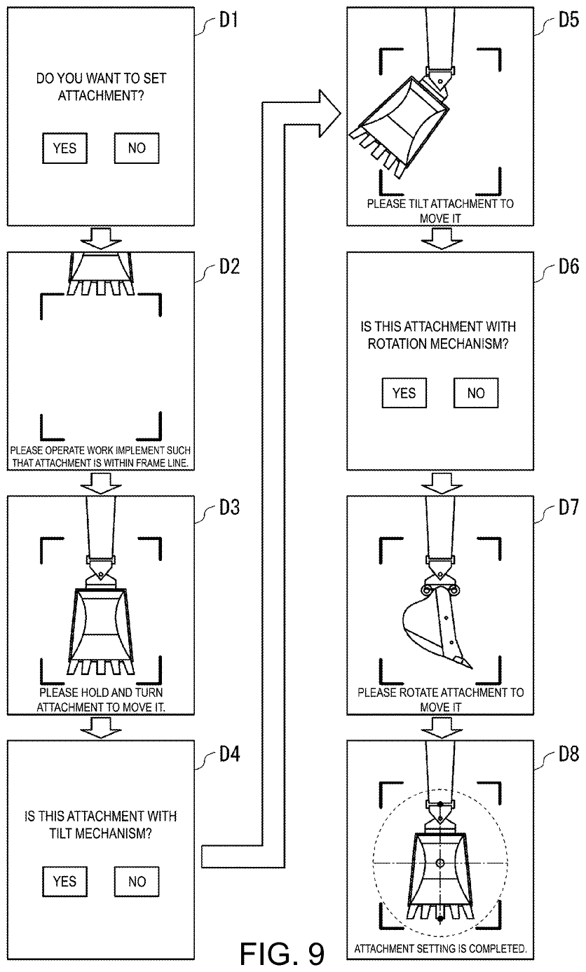

FIG. 7 is a flowchart (part 1) showing a shape identification process of the attachment 163 in the first embodiment. FIG. 8 is a flowchart (part 2) showing the shape identification process of the attachment 163 in the first embodiment. FIG. 9 is a diagram illustrating an example of a screen in the shape identification process according to the first embodiment.

The display control unit 213 displays a first instruction screen D1 (FIG. 9) on the monitor device 142 (step S101). The first instruction screen D1 is provided with a “YES button” which indicates the start of the shape identification process of the attachment 163 and a “NO button” which indicates that the shape identification process of the attachment 163 is not to be executed. When the operator executes the shape identification process of the attachment 163, the operator operates the “YES button” displayed on the first instruction screen D1 of the monitor device 142. The input unit 212 receives an operation input of the “YES button” or the “NO button” by the operator via the monitor device 142 (step S102).

When the operation input of the “NO button” by the operator is received (step S102: NO), the processor 210 ends the shape identification process of the attachment 163. In this case, the previously set data of the control point P and the radius r of the attachment 163 are continuously used.

When the operation input of the “YES button” by the operator is received (step S102: YES), the measurement value acquisition unit 214 starts acquiring various measurement values and imaging data (step S103). Furthermore, the position identification unit 215 starts calculating the position of the arm top in the vehicle body coordinate system based on the measurement value acquired in step S103 (step S104). Thereafter, the measurement value acquisition unit 214 and the position identification unit 215 continuously acquire various measurement values and imaging data and calculate the position of the arm top while the shape identification process is being executed.

Next, the display control unit 213 causes the monitor device 142 to display a second instruction screen D2 (step S105). The second instruction screen D2 includes the imaging data acquired by the measurement value acquisition unit 214, a framing element, and an instruction to prompt the operation of the work implement 160 to insert the attachment 163 into the framing element. The framing element is a frame line that represents a predetermined range, and represents a positioning element of the attachment 163.

Next, the attachment identification unit 216 determines whether or not the image of the attachment 163 is within the framing element on the second instruction screen D2 (step S106). The attachment identification unit 216 may determine whether or not the image of the attachment 163 is within the framing element based on the position of the arm top identified in step S104, for example. Since the position of the imaging device 107 is fixed in the vehicle body coordinate system, the imaging range of the imaging device 107 can be identified from the vehicle body coordinate system. Therefore, by determining whether or not the arm top is located in a predetermined area of the imaging range in the vehicle body coordinate system that corresponds to the top of the framing element, it is possible to determine whether or not the image of the attachment 163 is within the framing element. Furthermore, the attachment identification unit 216 may identify the position of the attachment by a technique such as pattern matching based on the imaging data acquired in step S103.

When the image of the attachment 163 is not within the framing element (step S106: NO), the process returns to step S105, and the display of the second instruction screen D2 continues.

When the image of the attachment 163 is within the framing element (step S106: YES), the display control unit 213 causes the monitor device 142 to display a third instruction screen D3 (step S107). The third instruction screen D3 includes the imaging data acquired by the measurement value acquisition unit 214, a framing element, and an instruction to prompt a holding operation and a turning operation of the attachment 163. The holding operation and the turning operation are operations in which the attachment 163 is rotated around the pin (around a Y_{bk} axis) by extending and retracting the attachment cylinder 118.

The attachment identification unit 216 identifies the position of the lowest point of the attachment 163 in the image coordinate system (a two-dimensional coordinate system including Xₚ axis and Yₚ axis), which is the coordinate system of the imaging data, from the imaging data (step S108). The lowest point in the image coordinate system is the point with the largest Yₚ coordinate value in the image coordinate system within the area in which the image of the attachment 163 is shown in the imaging data. The attachment identification unit 216 identifies the position of the lowest point of the attachment 163 in the vehicle body coordinate system based on the position of the arm top identified by the position identification unit 215 and the position of the lowest point identified in step S108 (step S109). Note that since the image coordinate system is a two-dimensional coordinate system, the position of the lowest point in the line-of-sight direction (depth direction) of the imaging device 107 cannot be identified. Here, the attachment identification unit 216 identifies the position on the assumption that the lowest point exists on an axis that passes through the arm top and extends in the up-down direction of the imaging device 107. This is because it is assumed that when the tip end portion of the attachment 163 reaches its lowest point, the attachment 163 and the imaging device 107 will be directly facing each other, and the tip end portion will be positioned on an axis that passes through the arm top and extends in the up-down direction of the imaging device 107.

The attachment identification unit 216 temporarily stores the position of the lowest point in the main memory 230 in association with the attachment angle (step 110). The attachment identification unit 216 determines whether or not the maximum value of the position of the lowest point with respect to the attachment angle can be identified based on the relationship between the position of the lowest point and the attachment angle stored in the main memory 230 (step S11). When the maximum value cannot be identified (step S11: NO), the attachment identification unit 216 returns the process to step S107 and continues to display the third instruction screen D3.

When the maximum value can be identified (step S11: YES), the attachment identification unit 216 determines the position of the control point P of the attachment 163 in the attachment coordinate system based on the position of the lowest point related to the maximum value and the position of the arm top (step S112). Specifically, the attachment identification unit 216 determines the position of the control point P in the following procedure. The attachment identification unit 216 estimates the position of the lowest point related to the maximum value as the position of the tip end portion of the attachment 163. The attachment identification unit 216 determines the position of the tip end portion in the attachment coordinate system based on the position of the lowest point related to the maximum value and the attachment angle corresponding thereto. The attachment identification unit 216 determines the position of a control point P, which is the midpoint between the arm top and the tip end portion, based on the position of the arm top in the attachment coordinate system (the origin of the attachment coordinate system) and the position of the tip end portion.

In addition, the attachment identification unit 216 determines the radius r of the virtual sphere VS based on the position of the tip end portion of the attachment 163 (step S113). Specifically, the attachment identification unit 216 determines the distance between a corner of the tip end portion of the attachment 163 (for example, the right end of the blade tip) and the control point P as the radius r.

The attachment identification unit 216 records the position and the radius r of the control point P in the main memory 230.

Next, the display control unit 213 displays a fourth instruction screen D4 on the monitor device 142 (step S114). The fourth instruction screen D4 is provided with a “YES button” which indicates the start of an analysis of the tilt mechanism provided in the attachment 163, and a “NO button” which indicates that the analysis of the tilt mechanism is not to be executed. The input unit 212 receives an operation input of the “YES button” or the “NO button” by the operator via the monitor device 142 (step S115).

When the operation input of the “YES button” by the operator is received (step S115: YES), the display control unit 213 causes the monitor device 142 to display a fifth instruction screen D5 (step S116). The fifth instruction screen D5 includes the imaging data acquired by the measurement value acquisition unit 214, a framing element, and an instruction to prompt a tilt operation of the attachment 163. The tilt operation is an operation of rotating the attachment 163 around a Zek axis.

The attachment identification unit 216 tracks the position of the tip end portion of the attachment 163 in the imaging data by using an object tracking technology (step S117). The object tracking technology is a technology that estimates how a designated target moves in an image based on a time series of imaging data, that is, a moving image. Specifically, the attachment identification unit 216 uses a partial image of the periphery of the tip end portion of the attachment 163 determined in step S112 from among the imaging data to estimate the position of that partial image in the newly acquired imaging data.

The attachment identification unit 216 determines whether or not a posture at the maximum tilt angle that can be taken by a tilt operation has been detected (step S118). For example, when the maximum value of the height of the tip end portion is detected due to a tilt operation turning back in a time series of the position of the tip end portion identified by object tracking, it can be determined that the posture at the maximum tilt angle has been detected. Also, for example, the attachment identification unit 216 may receive an input from the operator operating the monitor device 142 to indicate that the posture at the maximum tilt angle has been taken.

When the posture at the maximum tilt angle has not been detected (step S118: NO), the attachment identification unit 216 returns the process to step S116 and continues to display the fifth instruction screen D5.

When the posture at the maximum tilt angle is detected (step S118: YES), the attachment identification unit 216 determines whether or not the distance between the corner of the tip end portion of the attachment 163 in the posture at the maximum tilt angle and the control point P is longer than the radius r of the virtual sphere VS (step S119). Since the position of the control point P does not change due to the tilt operation, the distance between the corner and the control point P changes due to the tilt operation. When the distance between the corner of the tip end portion and the control point P is longer than the radius r (step S119: YES), the radius r is updated (step S120). Accordingly, the radius r of the virtual sphere VS becomes the distance from the control point P to the farthest point in all postures that can be taken by the tilt operation of the attachment 163. Accordingly, it is possible to control the attachment 163 such that it does not enter the virtual wall VW, regardless of the tilt angle of the attachment 163. When the distance between the corner of the tip end portion and the control point P is equal to or less than the radius r (step S119: NO), the radius r is not updated.

When the analysis of the tilt mechanism is completed by the processing from step S116 to step S120, or when the operation input of the “NO button” by the operator is received on the fourth instruction screen D4 (step S115: NO), the display control unit 213 displays a sixth instruction screen D6 on the monitor device 142 (step S121). The sixth instruction screen D6 is provided with a “YES button” which indicates the start of an analysis of the rotation mechanism provided in the attachment 163, and a “NO button” which indicates that the analysis of the rotation mechanism is not to be executed. The input unit 212 receives an operation input of the “YES button” or the “NO button” by the operator via the monitor device 142 (step S122).

When the operation input of the “YES button” by the operator is received (step S122: YES), the display control unit 213 causes the monitor device 142 to display a seventh instruction screen D7 (step S123). The seventh instruction screen D7 includes the imaging data acquired by the measurement value acquisition unit 214, a framing element, and an instruction to prompt a rotation operation of the attachment 163. The rotation operation is an operation of rotating the attachment 163 around an X_{bk} axis.

The attachment identification unit 216 determines whether or not the side surface of the attachment 163 directly faces the imaging device 107 in the imaging data (step S124). For example, the attachment identification unit 216 calculates the area of the region in which the attachment 163 is shown in the imaging data acquired successively, and when the attachment 163 is not facing forward and the area is extremely small, the attachment identification unit 216 determines that the side surface of the attachment 163 directly faces the imaging device 107. Also, for example, the attachment identification unit 216 may determine that the side surface of the attachment 163 directly faces the imaging device 107 by pattern matching with the known shape of the side surface of the attachment 163.

When the side surface of the attachment 163 does not directly face the imaging device 107 (step S124: NO), the attachment identification unit 216 returns the process to step S121 and continues to display the seventh instruction screen D7.

When the side surface of the attachment 163 directly faces the imaging device 107 (step S124: YES), the attachment identification unit 216 calculates the distance between the position of the arm top and the tip end portion, and updates the position of the control point P, which is the midpoint between the arm top and the tip end portion (step S125). This is because an image showing the side surface of the attachment 163 more accurately represents the positional relationship between the arm top and the tip end portion than an image showing the front of the attachment 163.

When the analysis of the rotation mechanism is completed by the processing from step S121 to step S123, or when the operation input of the “NO button” by the operator is received on the sixth instruction screen D6 (step S122: NO), the display control unit 213 displays a confirmation screen D8 on the monitor device 142 (step S126). The confirmation screen D8 includes the imaging data acquired by the measurement value acquisition unit 214 and the virtual sphere VS with the control point P as its center.

In this manner, the control device 200 can identify the virtual sphere VS that includes the attachment 163 and record the data of the virtual sphere VS in the main memory 230.

### Setting Process of Virtual Wall VW

The operator of the work machine 100 operates the monitor device 142 to set the virtual wall VW. When the input unit 212 receives an instruction to set a virtual wall VW from the monitor device 142, the display control unit 213 causes the monitor device 142 to display a selection screen for the type of the virtual wall VW to be set. The control device 200 can set five types of virtual walls VW: a front wall, a left wall, a right wall, an upper wall, and a lower wall. The front wall, the left wall, and the right wall are wall surfaces that extend in the vertical direction. The upper wall and the lower wall are wall surfaces that extend in the horizontal direction. The virtual wall VW is represented by a normal vector indicating the normal direction of the virtual wall VW and a position vector indicating the position of a point through which the virtual wall VW passes, both of which are defined in the vehicle body coordinate system.

The work machine 100 can perform work within the reach of the work implement 160 by revolving the revolving body 140. Therefore, typically, the operator revolves the work machine 100 when performing work such as excavation. The vehicle body coordinate system is based on the revolving body 140 and therefore rotates following the revolution of the work machine 100 when viewed from the viewpoint of the global coordinate system. When the virtual wall VW set in the vehicle body coordinate system rotates following the revolution of the work machine 100, the right wall and the left wall do not interfere with the work machine 100 and this is meaningless. For example, when a right wall is set on the right side of the revolving body 140, the right wall is always maintained on the right side of the revolving body 140 regardless of how the revolving body 140 is revolved and does not interfere with the work machine 100. Furthermore, when the front wall rotates following the revolution of the work machine 100, it behaves as an annular wall rather than a planar wall, and therefore does not function as a virtual wall VW along the wall surface of the building.

Therefore, the control device 200 according to the first embodiment performs a rotation conversion process of the virtual wall VW in order to maintain the position of the virtual wall VW in the global coordinate system before and after the work machine 100 revolves.

### Update and Intervention Control of Virtual Wall VW

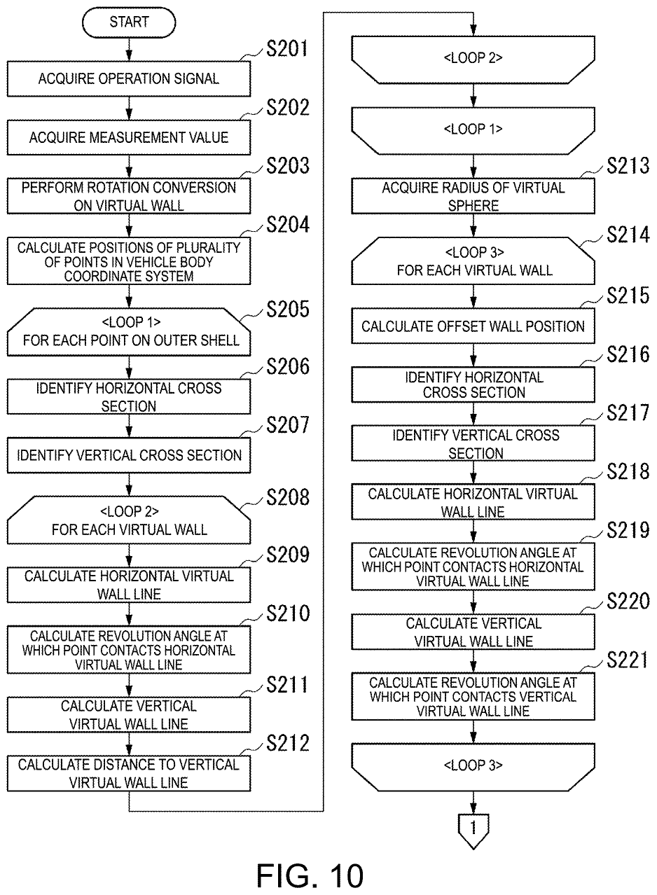

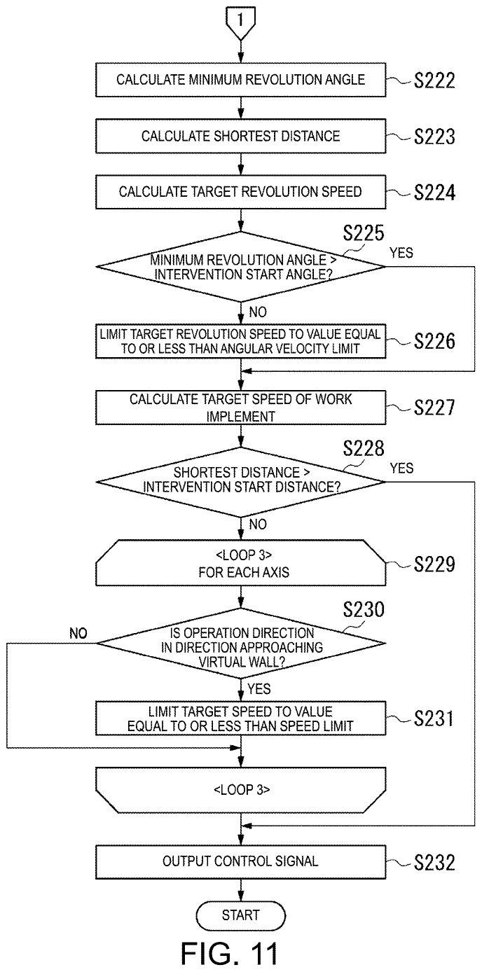

FIG. 10 is a flowchart (part 1) showing update and intervention control of the virtual wall VW set in the first embodiment. FIG. 11 is a flowchart (part 2) showing update and intervention control of the virtual wall VW set in the first embodiment. When the operator of the work machine 100 sets at least one virtual wall VW by operating the monitor device 142, the control device 200 starts the control described below.

The operation amount acquisition unit 211 acquires operation signals of the boom 161, the arm 162, the attachment 163, and the revolving body 140 from the operation device 141 (step S201). The measurement value acquisition unit 214 acquires the measurement values of the inclination measuring instrument 101, the revolution angle sensor 102, the boom angle sensor 103, the arm angle sensor 104, the attachment angle sensor 105, and the payload meter 106 (step S202).

The rotation conversion unit 218 rotationally converts and updates each of one or more virtual walls VW stored in the main memory 230 based on the roll angle, the pitch angle, and the yaw angle of the revolving body 140 acquired from the inclination measuring instrument 101 in step S202 (step S203).

The position identification unit 215 calculates the positions of a plurality of points on the outer shell of the work machine 100 and the control point P of the attachment 163 in the vehicle body coordinate system based on the measurement values acquired in step S202 (step S204). The intervention determination unit 219 selects one by one from points on the outer shell identified by the position identification unit 215 (step S205), and executes the following processes from step S206 to step S212.

The intervention determination unit 219 identifies a cross section that passes through the point selected in step S205 and is parallel to the X_{sb}-Y_{sb} plane of the vehicle body coordinate system (step S206). Furthermore, the intervention determination unit 219 identifies a cross section that passes through the point selected in step S205 and is parallel to the X_{sb}-Z_{sb} plane of the vehicle body coordinate system (step S207).

The intervention determination unit 219 selects one by one from one or more virtual walls VW set in the main memory 230 (step S208), and executes the following processes from step S209 to step S212.

The intervention determination unit 219 calculates an intersection line between the cross section generated in step S206 and the virtual wall VW selected in step S208 as a horizontal virtual wall line (step S209). Depending on the positional relationship between the cross section generated in step S206 and the virtual wall VW, there may be cases where a horizontal virtual wall line does not exist. When a horizontal virtual wall line exists, the intervention determination unit 219 obtains the revolution angle at which the point selected in step S205 contacts the horizontal virtual wall line calculated in step S209 for each of the right revolution and the left revolution (step S210). For example, the intervention determination unit 219 calculates an intersection between a circle centered on the revolution center and passing through the point selected in step S205 and the horizontal virtual wall line, and obtains the angle between the line segment extending from the revolution center to the point selected in step S205 and the line segment extending from the revolution center to the intersection. Depending on the positional relationship between the point selected in step S205 and the horizontal virtual wall line, there may be cases where an intersection does not exist.

In addition, the intervention determination unit 219 calculates an intersection line between the cross section generated in step S207 and the virtual wall VW selected in step S208 as a vertical virtual wall line (step S211). Depending on the positional relationship between the cross section generated in step S207 and the virtual wall VW, there may be cases where a vertical virtual wall line does not exist. When a vertical virtual wall line exists, the intervention determination unit 219 obtains the distance between the point selected in step S205 and the vertical virtual wall line calculated in step S211 (step S212).

Next, the intervention determination unit 219 executes the following processes from step S213 to step S221 for the control point P of the attachment 163 identified in step S204. The intervention determination unit 219 acquires the radius r of the virtual sphere VS from the main memory 230 (step S213).

The intervention determination unit 219 selects one by one from one or more virtual walls VW set in the main memory 230 (step S214), and executes the following processes from step S215 to step S221.

The intervention determination unit 219 calculates the position of an offset wall OW obtained by offsetting the virtual wall VW selected in step S214 in the normal direction by the length of the radius r acquired in step S213 (step S215). That is, the intervention determination unit 219 moves the virtual wall VW selected in step S214 closer to the control point P of the attachment 163 by the length of the radius r. The intervention determination unit 219 identifies a cross section that passes through the control point P of the attachment 163 and is parallel to the X_{sb}-Y_{sb} plane of the vehicle body coordinate system (step S216). Furthermore, the intervention determination unit 219 identifies a cross section that passes through the control point P of the attachment 163 and is parallel to the X_{sb}-Z_{sb} plane of the vehicle body coordinate system (step S217).

The intervention determination unit 219 calculates an intersection line between the cross section generated in step S216 and the offset wall OW obtained in step S215 as a horizontal virtual wall line (step S218). Depending on the positional relationship between the cross section generated in step S206 and the offset wall OW, there may be cases where a horizontal virtual wall line does not exist. When a horizontal virtual wall line exists, the intervention determination unit 219 obtains the revolution angle at which the control point P of the attachment 163 contacts the horizontal virtual wall line calculated in step S209 for each of the right revolution and the left revolution (step S219). This revolution angle is equivalent to the revolution angle at which the virtual sphere VS and the virtual wall VW come into contact with each other. For example, the intervention determination unit 219 calculates an intersection between a circle centered on the revolution center and passing through the control point P of the attachment 163 and the horizontal virtual wall line, and obtains the angle between the line segment extending from the revolution center to the control point P of the attachment 163 and the line segment extending from the revolution center to the intersection. Depending on the positional relationship between the control point P of the attachment 163 and the horizontal virtual wall line, there may be cases where an intersection does not exist.

In addition, the intervention determination unit 219 calculates an intersection line between the cross section generated in step S217 and the offset wall OW obtained in step S215 as a vertical virtual wall line (step S220). Depending on the positional relationship between the cross section generated in step S217 and the offset wall OW, there may be cases where a vertical virtual wall line does not exist. When a vertical virtual wall line exists, the intervention determination unit 219 obtains the distance between the control point P of the attachment 163 and the vertical virtual wall line calculated in step S220 (step S221). This distance is equivalent to the distance at which the virtual sphere VS and the virtual wall VW come into contact with each other.

The intervention determination unit 219 calculates the minimum revolution angle at which at least one of the plurality of points and the virtual sphere VS contacts at least one virtual wall VW for each of the right revolution and the left revolution, based on the revolution angles of each point on the work machine 100 and each virtual wall VW on the virtual sphere VS obtained in steps S210 and S219 (step S222).

The intervention determination unit 219 calculates the shortest distance between the work implement 160 and the virtual wall VW based on the distances to each point on the work machine 100 and each virtual wall VW on the virtual sphere VS obtained in steps S212 and S221 (step S223).

The intervention determination unit 219 calculates the revolution direction and the target revolution speed based on the operation signal of the revolving body 140 acquired in step S201 (step S224). The intervention determination unit 219 determines whether or not the minimum revolution angle in the revolution direction indicated by the operation signal is greater than the intervention start angle (step S225). When the minimum revolution angle is greater than the intervention start angle (step S225: YES), the intervention control unit 220 does not perform intervention control for the revolution. On the other hand, when the minimum revolution angle is equal to or less than the intervention start angle (step S225: NO), the intervention control unit 220 identifies the angular velocity limit from the minimum revolution angle based on a predetermined angular velocity limit table, and limits the target revolution speed of the revolving body 140 to a value equal to or less than the angular velocity limit (step S226). The angular velocity limit table is a function that indicates the relationship between the minimum revolution angle and the angular velocity limit, and is a function in which the smaller the minimum revolution angle, the smaller the angular velocity limit.

The angular velocity limit table may be set to a deceleration rate that does not impair the operator's controllability of the revolving body 140, for example.

The intervention determination unit 219 calculates a target speed of the work implement 160 based on the operation signals of the boom 161, the arm 162, and the attachment 163 acquired in step S201 (step S227). Specifically, the intervention determination unit 219 calculates target speeds of the boom 161, the arm 162, and the attachment 163 based on the operation signals of the boom 161, the arm 162, and the attachment 163 acquired in step S201. Next, the intervention determination unit 219 determines whether or not the shortest distance calculated in step S223 is longer than the intervention start distance (step S228). When the shortest distance is longer than the intervention start distance (step S228: YES), the intervention control unit 220 does not perform intervention control for the work implement 160. On the other hand, when the shortest distance is equal to or less than the intervention start distance (step S228: NO), the intervention control unit 220 selects each axis of the work implement 160 one by one, and performs the following processes from steps S230 to S231 for the selected axis (step S229). The intervention control unit 220 determines whether or not the operation direction of the selected axis is an operation in a direction approaching the virtual wall VW (step S230). When the operation direction of the selected axis is not an operation in a direction approaching the virtual wall VW (step S230: NO), the intervention control unit 220 does not perform intervention control for the selected axis. On the other hand, when the operation direction of the selected axis is an operation in a direction approaching the virtual wall VW (step S230: YES), the intervention control unit 220 identifies the speed limit for the selected axis based on a predetermined speed limit table, and limits the target speed to a value equal to or less than the speed limit (step S231).

The control signal output unit 221 generates a control signal based on the target speeds of the boom 161, the arm 162, and the attachment 163 and the target angular velocity of the revolving body 140, and outputs the control signal to the control valve 113 (step S232).

### Actions and Effects

In this manner, the control device 200 controls the work machine 100 in the following procedure. The control device 200 acquires imaging data from the imaging device 107. The control device 200 identifies the shape of the attachment 163 based on the imaging data. The control device 200 controls the work machine 100 based on the identified shape of the attachment 163 such that the virtual wall VW does not come into contact with the attachment 163.

Accordingly, when the attachment 163 is replaced, the control device 200 can easily determine the parameters of the attachment 163 by causing the imaging device 107 to capture an image of the attachment 163 and executing a shape identification process of the attachment 163.

Note that, although the control device 200 according to the first embodiment controls the attachment 163 so as not to come into contact with the virtual wall VW based on the virtual sphere VS that includes the attachment 163, the present disclosure is not limited thereto. For example, in another embodiment, a three-dimensional shape of the attachment 163 may be identified, and the attachment 163 may be controlled so as not to come into contact with the virtual wall VW based on the three-dimensional shape. For example, when the imaging device 107 generates three-dimensional data as imaging data, such as a stereo camera or a LiDAR, the control device 200 can obtain an image of the attachment 163 while changing the viewpoint through the holding operation and the turning operation of the attachment 163, and therefore can obtain three-dimensional data of the outer shell of the attachment 163 with high accuracy.

### Second Embodiment

The control device 200 of the work machine 100 according to the first embodiment calculates the position of the attachment 163 from the imaging data, and determines the parameters to be used for control. The control device 200 according to a second embodiment stores in advance parameters of a plurality of attachments 163 that can be attached to the work implement 160. The control device 200 then identifies the type of the attachment 163 based on the imaging data, and determines the parameters to be used for control from among pre-stored parameters.

The storage 250 of the control device 200 according to the second embodiment receives an input of image data, and stores an identification model that outputs identification information (such as a model number) of the attachment 163 shown in the image data. The identification model may be, for example, a trained model trained using a training dataset relating to a combination of image data showing the attachment 163 and identification information of the attachment 163. Furthermore, the storage 250 stores, for each attachment 163, the attachment identification information, the control point P related to the attachment 163, and the radius of the virtual sphere VS in association with each other.

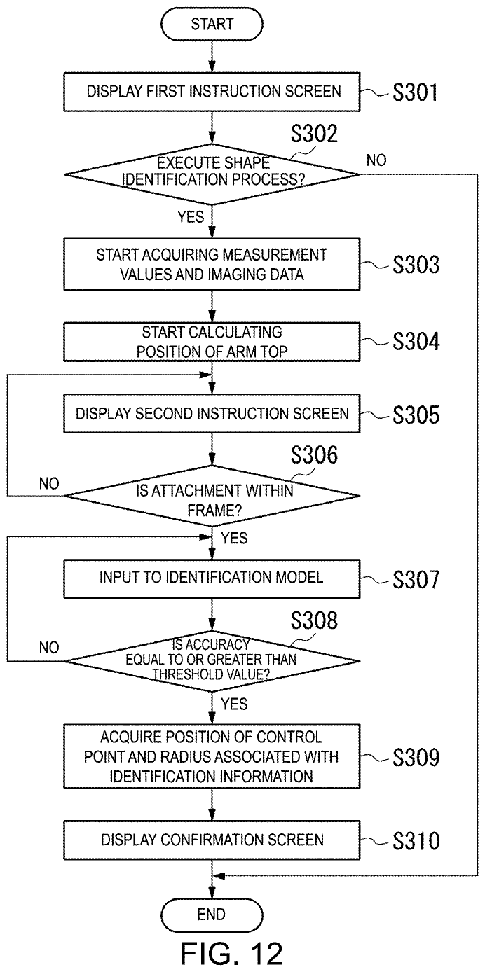

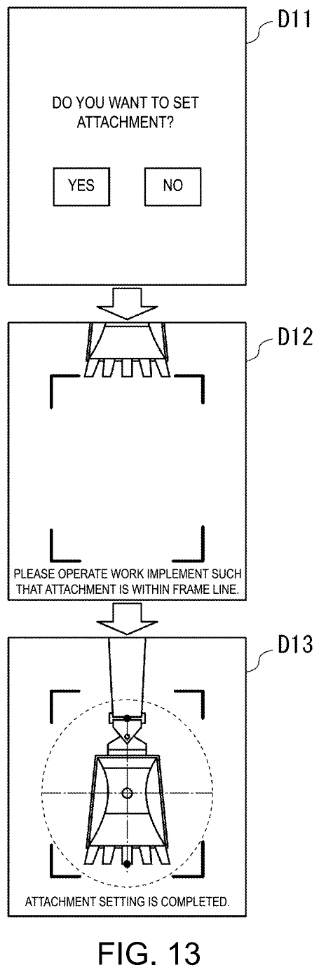

FIG. 12 is a flowchart showing a shape identification process of the attachment 163 in the second embodiment. FIG. 13 is a diagram illustrating an example of a screen in the shape identification process according to the second embodiment.

The display control unit 213 displays a first instruction screen D11 (FIG. 13) on the monitor device 142 (step S301). The first instruction screen D11 is provided with a “YES button” which indicates the start of the shape identification process of the attachment 163 and a “NO button” which indicates that the shape identification process of the attachment 163 is not to be executed. The input unit 212 receives an operation input of the “YES button” or the “NO button” by the operator via the monitor device 142 (step S302).

When the operation input of the “NO button” by the operator is received (step S302: NO), the shape identification process is ended. In this case, the previously set data of the control point P and the radius r of the attachment 163 are continuously used.

When the operation input of the “YES button” by the operator is received (step S302: YES), the measurement value acquisition unit 214 starts acquiring various measurement values and imaging data (step S303). Furthermore, the position identification unit 215 starts calculating the position of the arm top in the vehicle body coordinate system based on the measurement value acquired in step S303 (step S304). Thereafter, the measurement value acquisition unit 214 and the position identification unit 215 continuously acquire various measurement values and imaging data and calculate the position of the arm top while the shape identification process is being executed.

Next, the display control unit 213 causes the monitor device 142 to display a second instruction screen D12 (step S305). The second instruction screen D12 includes the imaging data acquired by the measurement value acquisition unit 214, a framing element, and an instruction to prompt the operation to insert the attachment 163 into the framing element. The framing element is a frame line that represents a predetermined range, and represents a positioning element of the attachment 163.

Next, the attachment identification unit 216 determines whether or not the image of the attachment 163 is within the framing element on the second instruction screen D12 (step S306). When the image of the attachment 163 is not within the framing element (step S306: NO), the process returns to step S305, and the display of the second instruction screen D12 continues.

When the image of the attachment 163 is within the framing element (step S306: YES), the attachment identification unit 216 inputs the imaging data into the identification model stored in the storage 250 (step S307). Identifying the type of the attachment 163 using an identification model based on the image of the attachment 163 shown in the imaging data is an example of a process of identifying the shape of the attachment 163. The attachment identification unit 216 acquires, as an identification result from the identification model, the identification information of the most accurate attachment 163 and its accuracy. The attachment identification unit 216 determines whether or not the accuracy is equal to or greater than a predetermined threshold value (step S308).

When the accuracy is less than the predetermined threshold value (step S308: NO), the attachment identification unit 216 returns the process to step S307, and again acquires imaging data to attempt identification. For example, when the image of the attachment 163 is blurred in the imaging data, the accuracy may be reduced.

When the accuracy is equal to or greater than a predetermined threshold value (step S308: YES), the attachment identification unit 216 acquires, from the storage 250, the position of the control point P and the radius r of the virtual sphere VS associated with the identification information included in the identification result, and records them in the main memory 230 (step S309).

After that, the display control unit 213 displays a confirmation screen D13 on the monitor device 142 (step S310). The confirmation screen D13 includes the imaging data acquired by the measurement value acquisition unit 214 and the virtual sphere VS with the control point P as its center.

In this manner, the control device 200 can determine the virtual sphere VS that includes the attachment 163 and record the data of the virtual sphere VS in the main memory 230.

### Actions and Effects

In this manner, the control device 200 controls the work machine 100 in the following procedure. The control device 200 acquires imaging data from the imaging device 107. The control device 200 identifies the shape of the attachment 163 based on the imaging data. The control device 200 controls the work machine 100 based on the shape such that the virtual wall VW does not come into contact with the attachment 163.

Accordingly, when the attachment 163 is replaced, the control device 200 can easily determine the parameters of the attachment 163 by causing the imaging device 107 to capture an image of the attachment 163.

Note that, although the control device 200 according to the second embodiment identifies the attachment 163 using a trained model, the present disclosure is not limited thereto. For example, in another embodiment, the control device 200 may store appearance image data representing the shape of the attachment 163 for each attachable attachment 163, and identify the attachment 163 by pattern matching the appearance image data with the imaging data.

Further, the control device 200 according to the second embodiment repeatedly performs identification using an identification model until the identification angle becomes equal to or greater than a threshold value, but the present disclosure is not limited thereto. For example, in another embodiment, when the identification fails, the parameter may be manually input by an operator. In another embodiment, when the identification fails, the parameters may be determined by the processes shown in steps S101 to S126 (FIG. 8) according to the first embodiment.

### Other Embodiments

An embodiment has been described above in detail with reference to the drawings, but a specific configuration is not limited to that described above, and various design changes and the like can be made. That is, in other embodiments, the order of the processing described above may be changed as appropriate. Further, some processing may be executed in parallel.

The control device 200 according to the embodiment described above may be constituted by a single computer. The configuration of the control device 200 may be divided into a plurality of computers, and the plurality of computers may cooperate with each other and serve as the control device 200. In this case, some of the computers constituting the control device 200 may be mounted inside the work machine 100, and other computers may be provided outside the work machine 100.

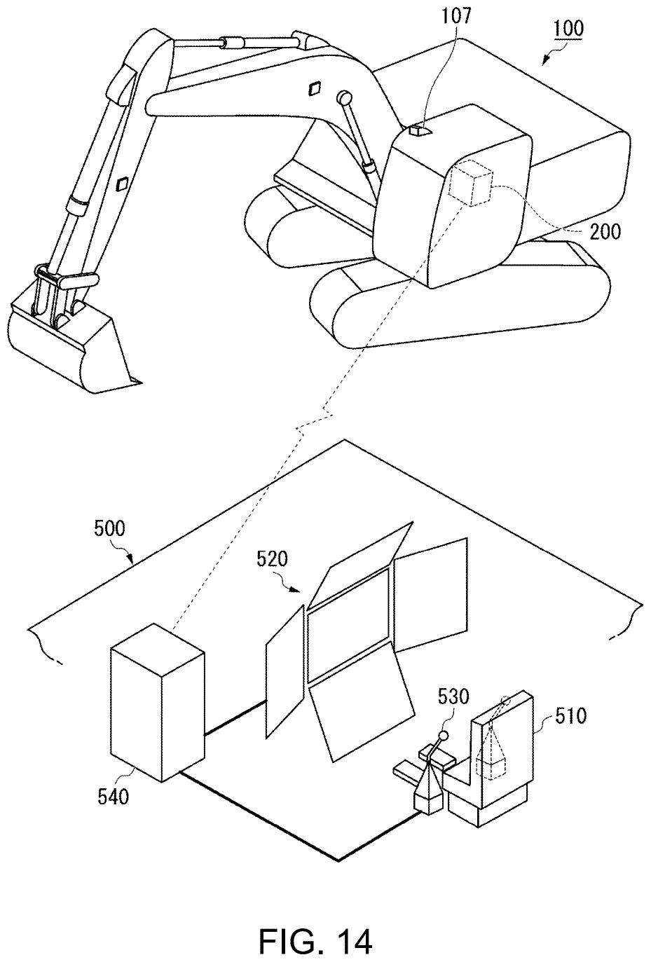

The work machine 100 according to the embodiment described above is operated by an operator who sits in the cab 180, but the work machine 100 according to another embodiment is not limited thereto. FIG. 14 is a diagram illustrating a configuration of a work system according to another embodiment. The work machine 100 according to another embodiment may be operated by a remote operation device 500 as illustrated in FIG. 14. The control device 200 of the remotely operated work machine 100 transmits the imaging data of the imaging device 107 to the remote operation device 500 in real time. The remote operation device 500 includes an operator's seat 510, a display 520, an operation device 530, and a remote operation server 540. The remote operation server 540 causes the imaging data received from the work machine 100 to be displayed on the display 520. Accordingly, the operator can recognize the situation around the remote work machine 100. Furthermore, the remote operation server 540 transmits operation signals from the operator on the operation device 530 to the work machine 100 via the network. The remote operation server 540 executes at least a part of the functions of the control device 200 according to the above embodiment. That is, in a work system including the remote operation server 540, the control device 200 and the remote operation server 540 constitute the work system.

Further, in the control device 200 according to the embodiment described above, the control point P of the attachment 163 is set to the midpoint between the rotation axis and the tip end portion, but the present disclosure is not limited thereto. For example, in another embodiment, the control point P may be the center of the rotation axis of the attachment 163. When the control point P is the center of the rotation axis of the attachment 163, the control point P is determined regardless of the rotation angle of the attachment 163, and therefore the coordinate transformation calculation using the attachment-vehicle body transformation matrix T^{at}_{sb} shown in equation (3) can be omitted.

Further, the control device 200 according to the embodiment described above performs a rotation conversion process on the virtual wall VW in order to treat the virtual wall VW as a plane, but the present disclosure is not limited thereto. For example, in another embodiment, when it is desired that the virtual wall VW functions as an annular wall surrounding the work machine 100, it is not necessary to perform the rotation conversion process of the virtual wall VW. In this case, the virtual wall VW is a curved surface. Note that the control device 200 according to another embodiment may perform the rotation conversion process on the virtual wall VW defined as a curved surface.

### REFERENCE SIGNS LIST

100 . . . Work machine 101 . . . Inclination measuring instrument 102 . . . Revolution angle sensor 103 . . . Boom angle sensor 104 . . . Arm angle sensor 105 . . . Attachment angle sensor 106 . . . Payload meter 107 . . . Imaging device 111 . . . Power source 112 . . . Hydraulic pump 113 . . . Control valve 114 . . . Travel motor 115 . . . Revolution motor 116 . . . Boom cylinder 117 . . . Arm cylinder 118 . . . Attachment cylinder 120 . . . Traveling body 140 . . . Revolving body 141 . . . Operation device 142 . . . Monitor device 160 . . . Work implement 161 . . . Boom 162 . . . Arm 163 . . . Attachment 180 . . . Cab 200 . . . Control device 210 . . . Processor 211 . . . Operation amount acquisition unit 212 . . . Input unit 213 . . . Display control unit 214 . . . Measurement value acquisition unit 215 . . . Position identification unit 216 . . . Attachment identification unit 217 . . . Generation unit 218 . . . Rotation conversion unit 219 . . . Intervention determination unit 220 . . . Intervention control unit 221 . . . Control signal output unit 230 . . . Main memory 250 . . . Storage 270 . . . Interface P . . . Control point VS . . . Virtual sphere VW . . . Virtual wall

1. A system configured to control a work machine including a work implement to which a work tool is attachable at a tip end, the system comprising:
an imaging device provided in the work machine and configured to capture imaging data showing the work implement; and
a processor, wherein
the processor
acquires the imaging data from the imaging device,
identifies a shape of the work tool, based on the imaging data, and
controls the work machine, based on the shape, such that the work tool does not come into contact with a virtual wall being a surface that prohibits entry of the work implement.

2. The system according to claim 1, wherein
the processor
identifies a posture of the work implement, and
identifies the shape of the work tool, based on the imaging data and the posture of the work implement.

3. The system according to claim 1, further comprising:
a storage device configured to store data relating to a shape of each of a plurality of the work tools attachable to the work implement and data relating to a dimension of the work implement, wherein
based on the shape, a dimension of one of the plurality of work tools is read from the storage device, and
based on the dimension, the work machine is controlled such that the virtual wall and the one of the plurality of work tools do not come into contact with each other.

4. The system according to claim 1, wherein
the processor
determines a radius of a virtual sphere defined such that the virtual sphere includes the work tool with a control point of the work tool as a center, based on the shape of the work tool, and
controls the work machine, based on a position of the control point and the radius, such that the virtual wall and the virtual sphere do not come into contact with each other.

5. A method for controlling a work machine including a work implement to which a work tool is attachable at a tip end, the method comprising:
acquiring, from an imaging device provided in the work machine and configured to capture imaging data showing the work implement, the imaging data;
identifying a shape of the work tool, based on the imaging data; and
controlling the work machine, based on the shape, such that the work tool does not come into contact with a virtual wall being a surface that prohibits entry of the work implement.

6. A non-transitory computer storage medium storing a program, wherein the program causes a computer configured to control a work machine including a work implement to which a work tool is attachable at a tip end to execute:
acquiring, from an imaging device provided in the work machine and configured to capture imaging data showing the work implement, the imaging data;
identifying a shape of the work tool, based on the imaging data; and
controlling the work machine, based on the shape, such that the work tool does not come into contact with a virtual wall being a surface that prohibits entry of the work implement.
